(19) United States
(12) Patent Application Publication
(10) Pub. No.: US 2013/0069426 A1
(43) Pub. Date: Mar. 21, 2013

(54) HYBRID POWER AND ELECTRICITY SYSTEM FOR ELECTRIC VEHICLES

(71) Applicants: Yu-Hun Nien, Puli Township (TW); Kuo-Pao Kao, New Taipei City (TW)

(72) Inventors: Yu-Hun Nien, Puli Township (TW); Kuo-Pao Kao, New Taipei City (TW)

(73) Assignee: Yu-Hun Nien

(21) Appl. No.: 13/235,473

(22) Filed: Sep. 18, 2011

(51) Int. Cl. B60L 11/02; H02K 7/18; F01K 23/00; F01B 17/02; B60K 6/46

(52) U.S. Cl. 307/10.1; 60/716; 60/409; 60/412; 290/1 R; 180/65.245

(57) ABSTRACT

In a hybrid power and electricity system for an electric vehicle, the system provides two kinds of electricity sources for the electric vehicle to resolve conventional problems such as insufficient driving range and long charging time. The system includes a compressed gas power engine that uses compressed gas to generate power; a gas tank that supplies compressed gas to the compressed gas power engine; a generator that is driven by the compressed gas power engine to generate electricity; a battery that is charged by the generator or an external electricity source; a motor that propels the electric vehicle. The motor consumes electricity that is supplied by the battery or the generator driven by the compressed gas power engine. The electric vehicle can be driven and charged at the same time, and has an increased driving range. Furthermore, compressed gas is inexpensive and easily available.

### BACKGROUND

1. Technical Field

The present invention relates to a vehicle, and more particularly, to a hybrid power and electricity system for an electric vehicle.

2. Related Art

Nowadays most vehicles consume fossil fuel, the burning of which allows engines to output power to propel the vehicles. However, the burning of fossil fuel causes environment pollution and global warming. Alternatives to the burning of fossil fuel are proposed to resolve the problems.

An electric vehicle consumes zero or only a little fossil fuel and hence is more environment-friendly. An electric vehicle consumes electricity stored in a battery, which might not have enough capacity to store enough electricity. As a result, an electric vehicle cannot travel a long distance. Moreover, it takes too much time to charge the battery when the stored electricity is exhausted. This is why electric vehicles are still not popular enough to completely replace conventional vehicles consuming fossil fuel. The insufficient amount of charging equipment for electric vehicles is another factor hampering electric vehicles from becoming widespread.

Hybrid vehicles are proposed to resolve the aforementioned problems of electric vehicles. Although hybrid vehicle have long travel distance, long endurance, and low fuel consumption, they still consume gasoline or diesel and lead to environmental problems.

To deal with the problems of power engines consuming fossil fuel, the inventor of the present invention has proposed some other inventions on compressed gas power engine and been issued several patents. The patent/publication numbers of these patents are: TWI327621, U.S. Pat. No. 7,866,251B2, CN101333935B (200710109465.0), and PCT/CN 2007/001994. Generally speaking, the inventions use high-pressure gas to propel the piston of an engine cylinder. The compressed gas power engine does not discharge exhaust gas, nor does the engine aggravate the greenhouse effect. In addition, the compressed gas used by the compressed gas power engine is less expensive than fossil fuel. Moreover, it's quite easy to get compressed gas, and gas-filling apparatuses use well-known technologies are easy to build. As a result, the invention can save energy and reduce greenhouse gas emission.

The patent/publication numbers of other patents related to compressed gas power engine include U.S. Pat. No. 457,762A, U.S. Pat. No. 4,171,618, U.S. Pat. No. 1,512,205, U.S. Pat. No. 427,809A, CN2411353Y (99247926.6), CN1847621A (200510043222.2), CN1376595A (01111576.9), CN1184205A (97115790.1), CN2637737Y (03205250.2), and EP82200280.4 (0062933A1).

Despite the aforementioned advantages of compressed gas power engine, it still has some other drawbacks. For example, bottles containing high-pressure gas must be used to supply energy to the engine, so that the engine can propel the vehicle. The engine's output is directly affected by the bottles' pressure. As a result, the engine's output will keep dropping once the bottles start to supply gas. The driver can feel that the vehicle gradually becomes less powerful. This is more apparent when the vehicle is ascending a slope. Sometimes the vehicle cannot even overcome a slope. Moreover, when the bottles' storage almost comes to an end and the interior pressure is only a little bit higher than the atmospheric pressure, the remaining gas cannot propel the engine and becomes useless. The driver simply cannot make full use of the high-pressure gas in the bottles.

### BRIEF SUMMARY

An embodiment of the invention provides a hybrid power and electricity system for an electric vehicle. The system uses a battery to supply electricity to a motor to propel the vehicle. The system further has a compressed gas power engine that drives a generator to generate electricity to charge the battery or supply the motor.

An embodiment of the invention provides a hybrid power and electricity system for an electric vehicle to resolve the problem of swift declination of power output associated with conventional compressed gas power engines.

An embodiment of the invention provides a hybrid power and electricity system for an electric vehicle. The system can reduce the residual volume of compressed gas used by a compressed gas power engine so as to make the most use of compressed gas and increase the vehicle's driving range.

An embodiment of the invention provides a hybrid power and electricity system for an electric vehicle. The system uses a compressed gas power engine to drive a generator, which charges a battery so as to increase the vehicle's driving range.

An embodiment of the invention provides a hybrid power and electricity system for an electric vehicle. The system has two kinds of electricity sources. A battery can be charged anytime, even if the vehicle is running. The system resolves the charging problem associated with conventional electric vehicles and the problem of inferior battery endurance. The system also has lower cost and leads to less environmental pollution.

According to the present invention, a hybrid electricity system for an electric vehicle is provide, which comprises a compressed gas power engine that uses compressed gas to generate power; a gas tank that provides the compressed gas power engine with the compressed gas; a generator that is driven by the compressed gas power engine to generate electricity; and a battery that supplies electricity to the electric vehicle and is charged by an external power source or the generator.

In one aspect, the system further comprises an energy management module, wherein the battery inputs or outputs electricity through the energy management module, the electricity generated by the generator is provided to the energy management module, and the energy management module either charges the battery or supply electricity to a motor of the electric vehicle.

The energy management module comprises a voltage regulator, a charging and discharging control device, and a controller, the voltage regulator carries out voltage adjustment and stabilization on the electricity generated by the generator and then sends the resulting electricity to the charging and discharging control device, the controller controls whether to charge the battery or supply electricity to the motor of the electric vehicle.

A valve is installed between the gas tank and the compressed gas power engine, the energy management module has a controller and an electricity detection device, based on electricity remains in the battery detected by the electricity detection device, the controller opens the valve to supply gas to the compressed gas power engine or closes the valve.

In another aspect, the system further comprises a gas re-filling device of a first compressor, wherein the gas tank has at least a first gas tank and a second gas tank, a pressure of the first gas tank is larger than a pressure of the second gas tank, a pressure adjustment valve is installed between the first gas tank and the second gas tank, the second gas tank supplies the compressed gas to the compressed gas power engine, a valve is installed between the second gas tank and the compressed gas power engine, the compressed gas power engine drives the first compressor to supply gas to the second gas tank.

The gas re-filling device further comprises a second compressor, the compressed gas power engine drives the generator to supply electricity to the second compressor so as to enable the second compressor to supply gas to the second gas tank.

Moreover, according to the present invention, a hybrid power system for an electric vehicle is provided, which comprises a motor and the hybrid electricity system mentioned above, wherein the motor serves as a power source of the electric vehicle, the battery or the compressed gas power engine drives the generator to supply electricity to the motor.

One the other hand, according to the present invention, a vehicle with a fossil fuel engine comprising the hybrid power system mentioned above is provided.

The followings are some advantages of the invention's embodiments.

1. A battery is used to supply electricity to a motor, and an external electricity source can be used to charge the battery. As an alternatively, a compressed gas power engine drives a generator to charge the battery. Because there are multiple charging options, as long as one of the options is available, the battery can be charged.

2. The embodiments resolve the problem of low driving range associated with conventional electric vehicles. And the embodiments are more environment-friendly. The cost of driving is lower than conventional vehicles.

3. The battery can be charged even when the vehicle is running. There is no need to park the vehicle in order to charge the battery. Therefore the embodiments make the electric vehicles more convenient.

4. The embodiments resolve the problem of swift declination of power output associated with conventional compressed gas power engines. When a conventional compressed gas power engine directly propels a vehicle, the power output declines swiftly, and the driver can feel the apparent problem. But since the embodiments uses a compressed gas power engine to drive a generator to supply electricity to a motor and to charge a battery, the motor's output power does not decline swiftly. Only some power is required to drive the generator, and the motor's electricity can come from the battery. As a result, the embodiments do not have the problem of output power declination, which exists if the conventional compressed gas power engine is directly used to propel the vehicle. Furthermore, when the compressed gas supplied to the compressed gas power engine has a low pressure that is not enough to propel the vehicle, the compressed gas power engine can still drive the generator. Therefore, the embodiments make a better use of the compressed gas. Compared with the conventional structure in which the compressed gas power engine propels the vehicle directly, the embodiments increase the vehicle's driving range, keep the battery at a high voltage state, and keep the motor at a high power output state. As a result, the vehicle's power does not decline swiftly.

5. Because it takes only a few minutes to refill a gas bottle, the embodiments resolve the problem of long charging time associated with conventional electric vehicles. Because the electricity comes from a battery and a generator driven by a gas power engine, the vehicle has a longer driving range.

6. It's easier to get high-pressure gas and the gas cost less. It's also easier and costs less to build a gas-filling station.

7. The battery of an electric vehicle costs roughly 30%˜50% of the vehicle's overall cost and hence is very expensive. They can sustain charging of no more than 2000 times. In the embodiments, both a battery and a generator driven by a gas power engine are used to supply electricity, and the generator supplies a large part of the overall electricity. As a result, the battery can be charged less frequently and hence can have a longer life.

8. When more power is needed, a compressed gas power engine can be used to supply a large amount of current, increasing the motor's torsion and maximum driving speed.

It is to be understood that both the foregoing general description and the following detailed description are exemplary and explanatory only and are not restrictive of the invention, as claimed.

### BRIEF DESCRIPTION OF THE DRAWINGS

FIG. 1 shows a top view of a vehicle using a hybrid power and electricity system according to an embodiment of the invention;

FIG. 2 shows a front view of the vehicle using the hybrid power and electricity system;

FIG. 3 shows a block diagram of a hybrid power and electricity system according to an embodiment of the invention;

FIG. 4 shows a front view of a motorcycle using a hybrid power and electricity system according to an embodiment of the invention;

FIG. 5 shows a top view of the motorcycle using the hybrid power and electricity system;

FIG. 6 illustrates how a hybrid power and electricity system according to an embodiment of the invention supplies current; and

FIG. 7 shows a gas re-filling device of a hybrid power and electricity system according to an embodiment of the invention.

### DETAILED DESCRIPTION

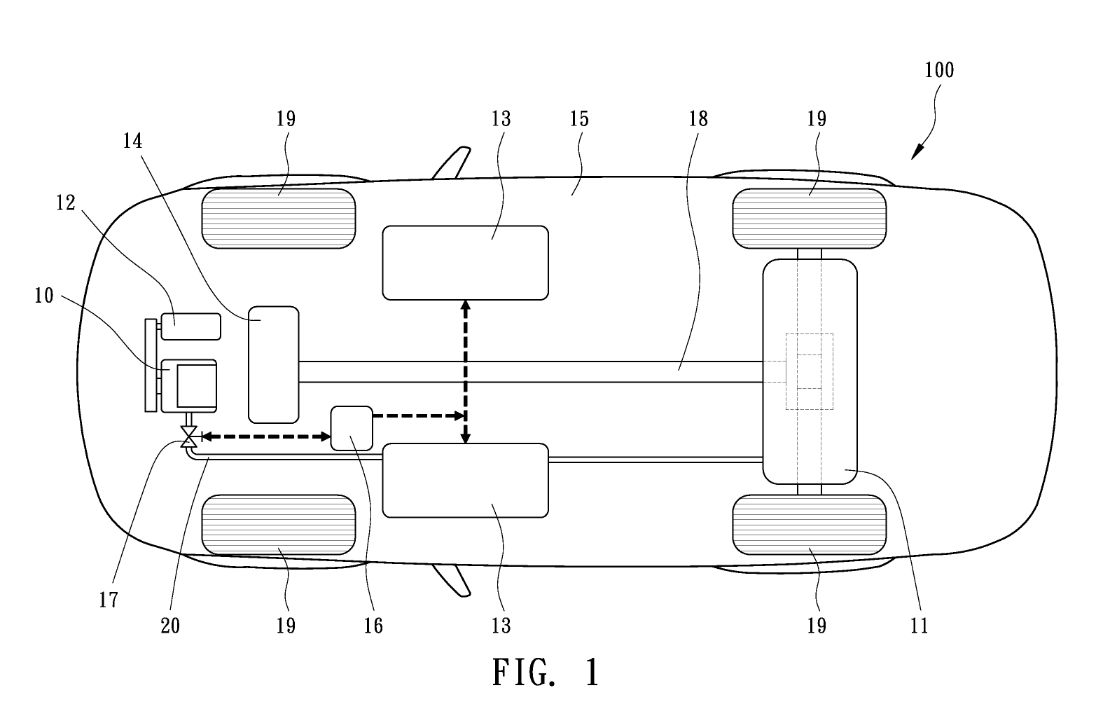

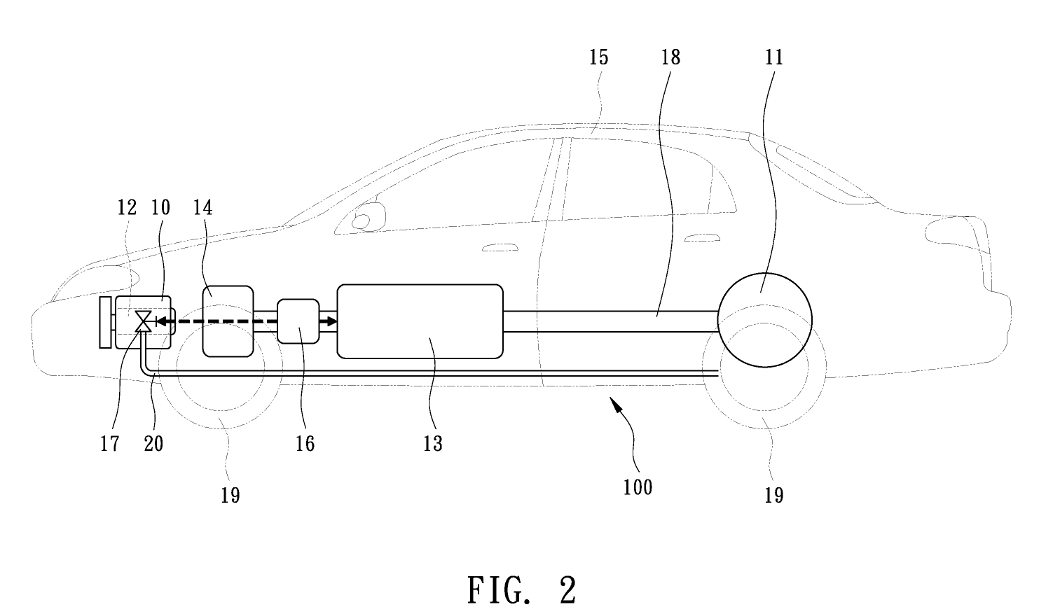

Based on a first embodiment of the invention, FIG. 1 to FIG. 3 illustrates a hybrid power system 100 for an electric vehicle. The hybrid power system 100 includes a compressed gas power engine 10, a gas tank 11, a generator 12, two batteries 13, and a motor 14. The motor 14 propels the electric vehicle 15, and the propelling power is transmitted to four wheels 19 through a driving shaft 18. Although the hybrid power system 100 is installed in a vehicle, it can also be installed in a motorcycle, an electric bicycle, or an electric tricycle.

The compressed gas power engine 10 receives high-pressure gas to generate power. For example, the compressed gas power engine 10 uses technologies proposed by the inventor in U.S. Pat. No. 7,866,251B2, which corresponds to Taiwan Patent Number TWI327621, China Patent Number CN101333935B (200710109465.0), and PCT/CN Patent Number 2007/001994. The gas tank 11 is used to store and supply compressed high-pressure gas. For example, the gas tank 11 is a steel cylinder filled with gas until the stored gas reaches a high pressure, and the filled gas is air or nitrogen. A pipe 20 and a valve 17 are connected between the compressed gas power engine 10 and the gas tank 11. When the valve 17 is opened, the gas tank 11 supplies gas to the compressed gas power engine 10. When the valve 17 is closed, the gas tank 11 does not supply gas.

The generator 12 is driven by the compressed gas power engine 10 to generate electricity. In this embodiment the generator 12 is a DC generator, supplying DC current to the motor 14 and the batteries 13. The batteries 13 can be charged by the generator 12 or an external electricity source, such as commercial electricity that has been regulated and rectified. Examples of the batteries 13 include lead acid batteries and LiFePO4 batteries. The batteries 13 can also be other types of batteries.

The motor 14 supplies power to the electric vehicle 15. Either the batteries 13 or the compressed gas power engine 10 or both is used to cause the generator 12 to generate electricity required by the motor 14.

The batteries 13 supply electricity to the electric vehicle 15. The batteries 13 is charged by an external power source or the generator 12, wherein the generator is driven by the compressed gas power engine 10. Therefore, the hybrid electricity system of this embodiment has two sources of electricity.

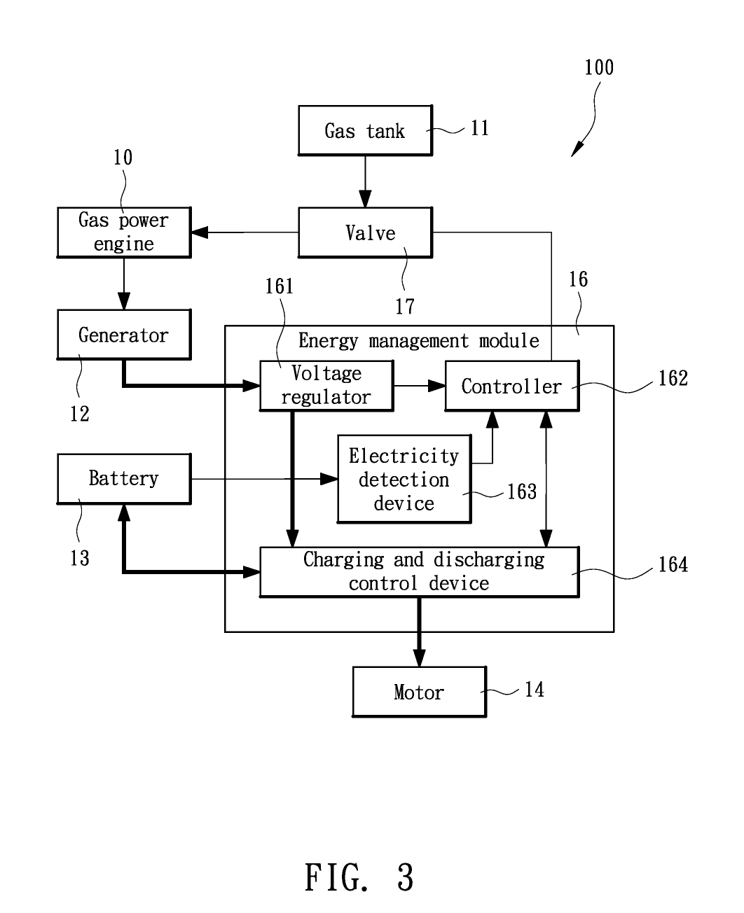

FIG. 3 shows a system block diagram of the aforementioned embodiment. As shown in the figure, the hybrid power system 100 further includes an energy management module 16. The energy management module 16 includes a voltage regulator 161, a controller 162, an electricity detection device 163, and a charging and discharging control device 164.

The batteries 13 input and output electricity through the energy management module 16. The electricity generated by the generator 12 is also provided to the energy management module 16. The energy management module 16 uses the electricity to charge the batteries 13 and/or supplies the electricity to the motor 14.

The voltage regulator 161 regulates the electricity generated by the generator 12, and supplies the regulated electricity to the charging and discharging control device 164. The controller 162 controls the charging and discharging control device 164 to charge the batteries 13 or supply the regulated electricity to the motor 14.

The energy management module 16 detects the remaining electricity of the batteries 13 to determine whether to open the gas tank 11 to supply gas to the compressed gas power engine 10. The electricity detection device 163 of the energy management module 16 is responsible for detecting the remaining electricity of the batteries 13. If it's detected that the batteries 13 do not have enough electricity remaining, the controller 162 will open the valve 17 so that the compressed gas power engine 10 can driver the generator 12. If it's detected that the batteries 13 have sufficient electricity remaining, the controller 162 will close the valve 17 so as to turn off the compressed gas power engine 10 and the generator 12. All these controls are conducted intelligently to achieve full automatic control.

Another embodiment of the invention provides two modes to open the gas tank 11 to supply gas to the compressed gas power engine 10 or to close the gas tank 11.

First mode: The opening of the valve 17 is based on the remaining electricity of the batteries 13. Under this mode, the electricity detection device 163 of the energy management module 16 is responsible for detecting the remaining electricity of the batteries 13. If it's detected that the batteries 13 do not have enough electricity remaining, the controller 162 will open the valve 17, so as to cause the compressed gas power engine 10 to drive the operation of the generator 12. As a result, the electricity required by the vehicle is completely supplied by the generator 12, which is driven by the compressed gas power engine 10. If it's detected that the batteries 13 have sufficient electricity remaining, the controller 162 will close the valve 17 so as to turn off the compressed gas power engine 10 and the generator 12. All these controls are conducted intelligently to achieve full automatic control.

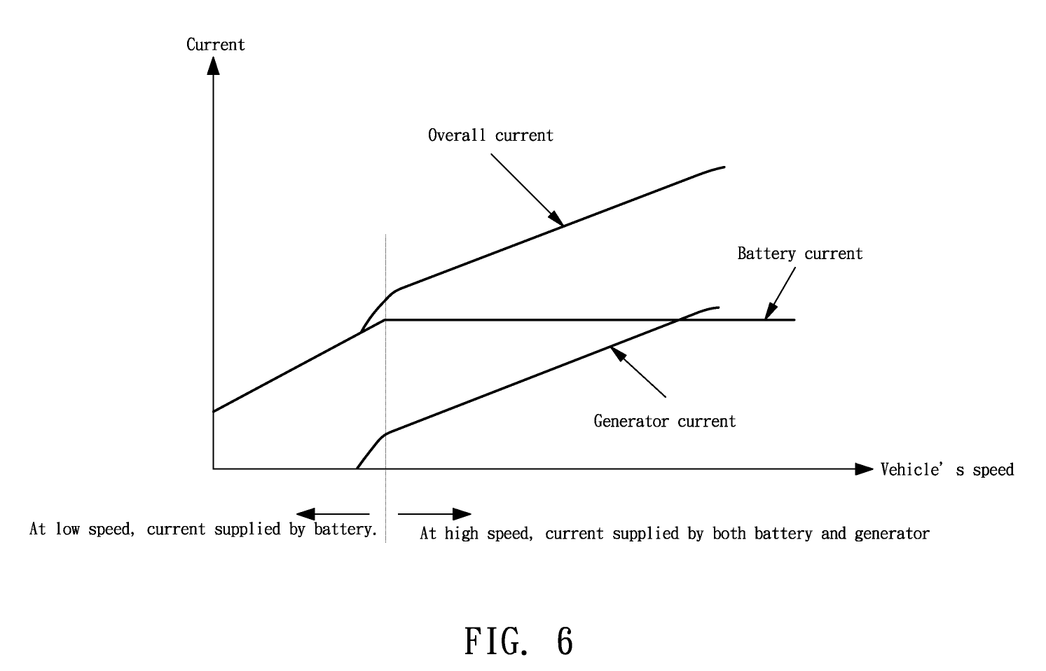

Second mode: The opening of the valve 17 is based on the remaining electricity of the batteries 13 and the vehicle's speed. Under this mode, the electricity detection device 163 of the energy management module 16 is responsible for detecting the remaining electricity of the batteries 13. If it's detected that the batteries 13 have sufficient electricity remaining, the electricity required to start the vehicle will be provided by the batteries 13. If the vehicle's speed exceeds a predetermined value, such as 30 kilometers per hour, the valve 17 is opened to start the compressed gas power engine 10. FIG. 6 shows how current is supplied under this mode. When the vehicle's speed is low, only the batteries 13 are used to supply electricity; when the vehicle's speed is high, both the batteries 13 and the generator 12 driven by the engine 10 are used to supply electricity.

When the vehicle is running at a high speed, if the electricity detection device 16 of the energy management module 16 detects that the batteries 13 have insufficient electricity, the energy management module 16 will start the charging function, directly using the electricity provided by the generator 12 to charge the batteries 13.

When the vehicle is not running or running at a low speed, if the electricity detection device 163 of the energy management module 16 detects that the batteries 13 have insufficient electricity, the controller 162 will open the valve 17 so as to start the compressed gas power engine 10 to drive the generator 12. In the meantime, the electricity required to drive the vehicle is completely provided by the generator 12. Once the vehicle starts to run at a high speed, it will enter the above mentioned mode in which both the batteries 13 and the generator 12 are used to drive the vehicle.

The two above mentioned electricity management modes are both useable. Theoretically, the mode using the remaining electricity of the batteries as an indication is relatively simple, but the gas engine is less efficient when the vehicle is running at a low speed. The second mode can increase the gas engine's efficiency, but is more complicated in terms of electricity management.

The above paragraphs introduce the components and electricity management methods of a hybrid power and electricity system for an electric vehicle according to an embodiment of the invention. The following paragraphs will introduce the characteristics of the embodiment.

First, the motor 14 serves as the main power source of the electric vehicle 15, propelling the electric vehicle 15. The batteries 13 can be charged by external electricity, such as commercial electricity, or by the generator 12, which is driven by the compressed gas power engine 10. The batteries 13 and the compressed gas power engine 10 can let the motor 14 drive the generator 12 to generate and supply electricity. All these can be controlled by the energy management module 16. When the vehicle is not in use, its owner can use commercial electricity to charge the vehicle. If the vehicle is in use and the batteries 13 have sufficient electricity remaining, the batteries 13 will supply electricity to the motor 14. If the vehicle is in use but the batteries 13 do not have sufficient electricity remaining, the compressed gas power engine 10 will drive the generator 12 to charge the batteries 13. All these can be managed intelligently by the energy management module 16. Because the electric vehicle can be driven and charge its batteries at the same time, the electric vehicle's driving range is increased, and has plentiful power, low cost of driving, and no pollution. In addition, it takes only a short time to refill the gas tank 11.

Aside from using high-pressure gas, the gas tank 11 can also use liquidated gas, such as liquidated nitrogen. However, the liquidated gas can be used only after evaporation in an evaporation chamber. The involved technologies are conventional and hence will not be explained hereby.

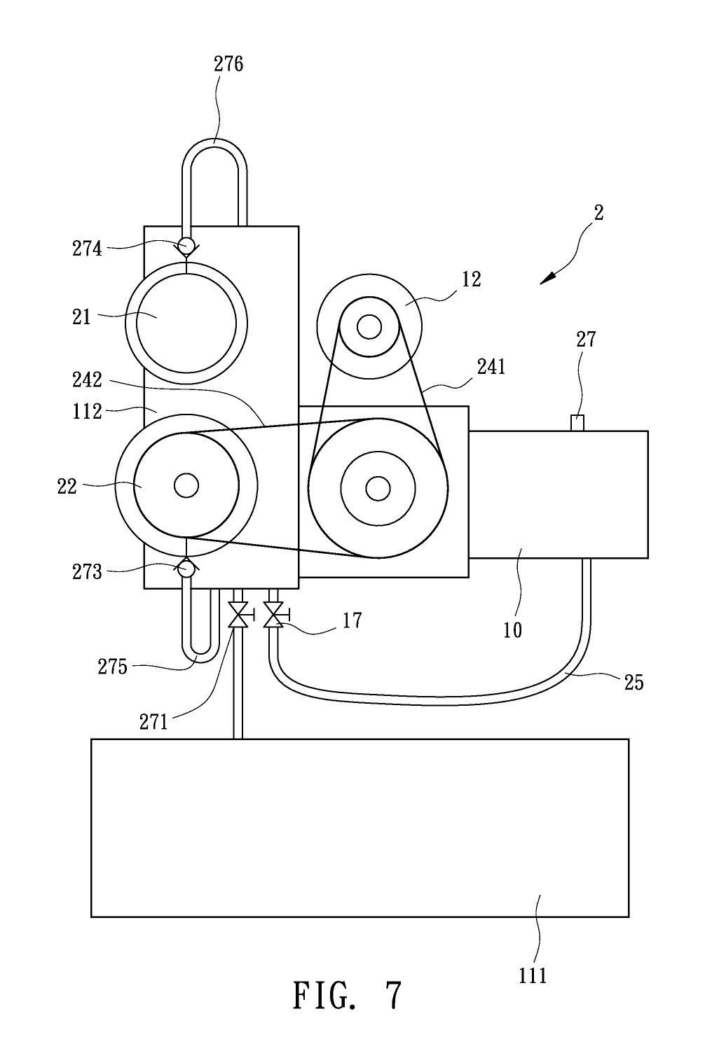

The hybrid power and electricity system will gradually run out of high-pressure gas. To increase the electric vehicle's driving range, an embodiment of the invention further includes a gas re-filling device 2 shown in FIG. 7 to recycle some of the surplus energy.

The following paragraphs provide two embodiments of the gas re-filling device 2.

In a first embodiment, the gas re-filling device 2 includes a first compressor 22. The gas tank 11 at least has a first gas tank 111 and a second gas tank 112. The pressure of the first gas tank 111 is higher than the pressure of the second gas tank 112. A pressure adjustment valve 271 lies between the first gas tank 111 and the second gas tank 112. The second gas tank 112 supplies compressed gas to the compressed gas power engine 10. A valve 17 lies between the second gas tank 112 and the compressed gas power engine 10. The compressed gas power engine 10 drives the first compressor 22 to refill the second gas tank 112.

In a second embodiment, the gas re-filling device 2 has a second compressor 21. The gas tank 11 has at least a first gas tank 111 and a second gas tank 112. The pressure of the first gas tank 111 is higher than the pressure of the second gas tank 112. A pressure adjustment valve 271 lies between the first gas tank 111 and the second gas tank 112. The second gas tank 112 supplies compressed gas to the compressed gas power engine 10. A valve 17 lies between the second gas tank 112 and the compressed gas power engine 10. The compressed gas power engine 10 drives the generator 12 to supply electricity to the second compressor 21 so that the second compressor 21 can refill the second gas tank 112.

The second gas tank 112 supplies sufficient compressed gas to drive the engine 10. The second compressor 21 consumes DC current and is directly driven by the DC generator 12.

As shown in FIG. 7, before the compressed gas power engine 10 is started, the pressure adjustment valve 271 must be opened so that high-pressure gas can come into the second gas tank 112 from the first gas tank 111. The gas flow is caused by the fact that the pressure of the first gas tank 111 filled with gas is higher than the pressure of the second gas tank 112. Once the pressure of the second gas tank 112 reaches a predetermined maximum, the pressure adjustment valve 271 automatically closes.

As shown in FIG. 7, when the compressed gas power engine 10 is started, the valve 17 is also opened so that the compressed gas in the second gas tank 112 will flow through the pipe 25 to enter the compressed gas power engine 10, driving the operation of the compressed gas power engine 10. After propelling the engine, the compressed gas will be discharged into the atmosphere through the exhaust vent 27. Because the compressed gas power engine 10's output torque is large enough, it can drive the first compressor 22 through the belt 242. The first compressor 22 compresses air in the atmosphere into the second gas tank 112 through the pipe 275, so as to supplement for the lost compressed gas. In the meantime, the compressed gas power engine 10 drives the DC generator 12 through the belt 241. The DC generator 12 supplies a small part of the generated electricity to the second compressor 21, which is a DC one and compresses some air in the atmosphere into to the second gas tank 112 through the pipe 276. The unidirectional valves 273 and 274 in the pipes 275 and 276 are necessary to prevent backward flow and prevent gas in the second gas tank 112 from leaking.

Although the second compressor 21 and the first compressor 22 can refill some compressed gas, they are not enough to compensate for the compressed gas lost in the process of driving the engine 10. Therefore, the high-pressure gas stored in the first gas tank 111 is also used to refill the second gas tank 112.

When the pressure of the second gas tank 112 is lower than a predetermined minimum value, the pressure throttle valve 271 between the second gas tank 112 and the first gas tank 111 will open automatically. As a result, the high-pressure gas in the first gas tank 111 will flow into the second gas tank 112. When the pressure of the second gas tank 112 is higher than a predetermined maximum value, the pressure throttle valve 271 will close automatically. The automatically control will ensure that the pressure in the second gas tank 112 be maintained between the predetermined maximum and minimum, and hence is suitable for driving the engine 10. Of cause, the first gas tank 111 will lose high-pressure gas gradually. If the pressure is too low, external equipment must be used to supply high-pressure gas into the first gas tank 111.

The gas refilling mechanism shown in FIG. 7 lowers down the gas losing speed, and hence increases the electric vehicle's driving range. The energy management module 16 can be used to intelligently control the operation of the gas refilling mechanism.

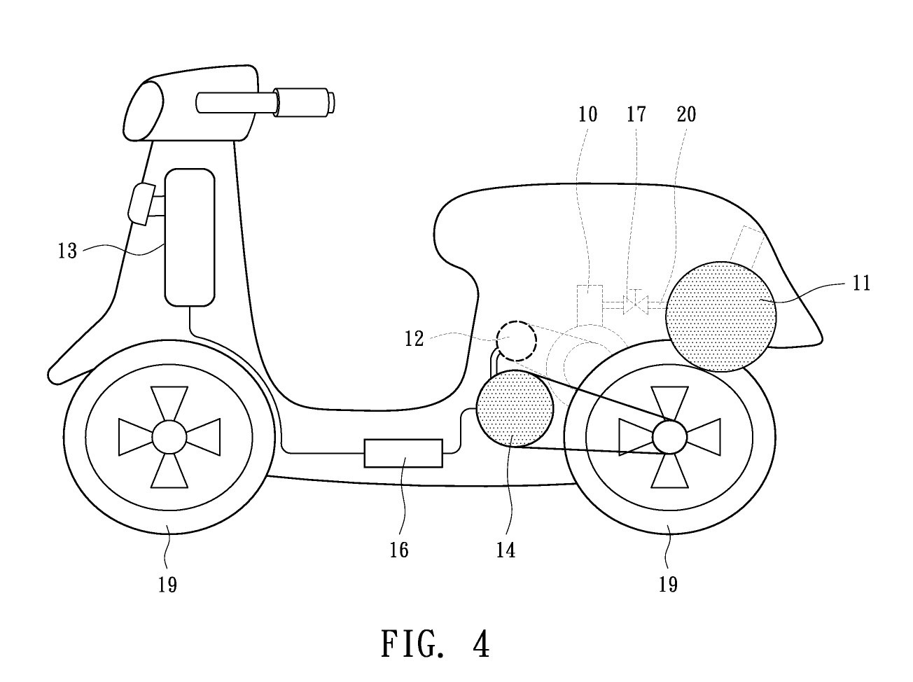

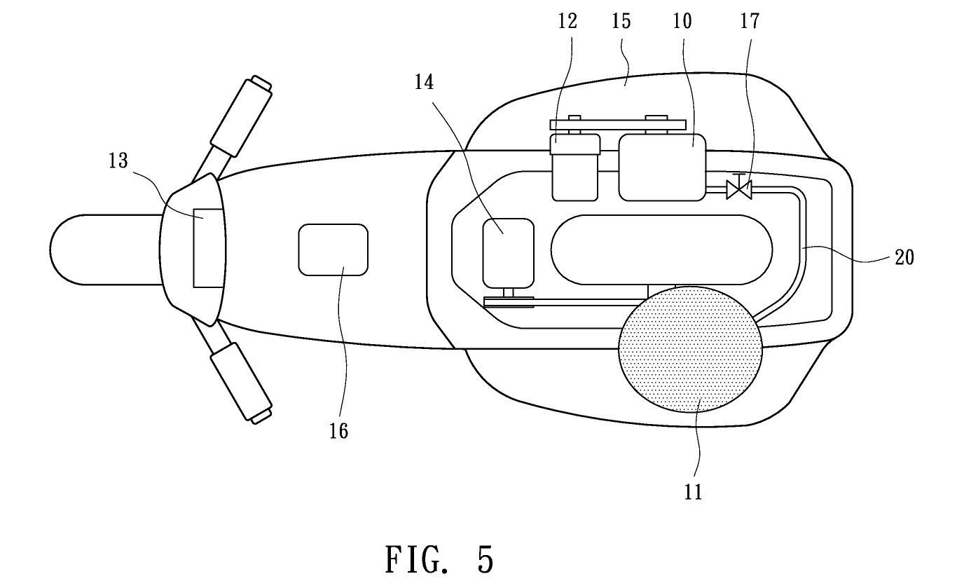

FIG. 4 and FIG. 5 show a front view and a top view, respectively, of a motorcycle using a hybrid power and electricity system according to an embodiment of the invention. The hybrid power and electricity system includes a compressed gas power engine 10, a gas tank 11, a generator 12, a battery 13, a motor 14, and an energy management module 16. The motor 14 propels the motorcycle 15. Aside from the fact that the hybrid power and electricity system of this embodiment is installed in a motorcycle, the system's components, functions, and characteristics are similar to those of the previous embodiments. Repetitive explanation is therefore omitted here.

Of course, the hybrid power and electricity system can also be used in a vehicle having a fossil fuel engine. The intelligent management of the energy management module 16 can increase the driving range of the vehicle, and lower down fuel consumption and carbon emission.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A hybrid electricity system for an electric vehicle, comprising:
a compressed gas power engine that uses compressed gas to generate power;
a gas tank that provides the compressed gas power engine with the compressed gas;
a generator that is driven by the compressed gas power engine to generate electricity; and
a battery that supplies electricity to the electric vehicle and is charged by an external power source or the generator.

2. The system of claim 1, further comprising an energy management module, wherein the battery inputs or outputs electricity through the energy management module, the electricity generated by the generator is provided to the energy management module, and the energy management module either charges the battery or supply electricity to a motor of the electric vehicle.

3. The system of claim 2, wherein the energy management module comprises a voltage regulator, a charging and discharging control device, and a controller, the voltage regulator carries out voltage adjustment and stabilization on the electricity generated by the generator and then sends the resulting electricity to the charging and discharging control device, the controller controls whether to charge the battery or supply electricity to the motor of the electric vehicle.

4. The system of claim 2, wherein a valve is installed between the gas tank and the compressed gas power engine, the energy management module has a controller and an electricity detection device, based on electricity remains in the battery detected by the electricity detection device, the controller opens the valve to supply gas to the compressed gas power engine or closes the valve.

5. The system of claim 1, further comprising a gas re-filling device of a first compressor, wherein the gas tank has at least a first gas tank and a second gas tank, a pressure of the first gas tank is larger than a pressure of the second gas tank, a pressure adjustment valve is installed between the first gas tank and the second gas tank, the second gas tank supplies the compressed gas to the compressed gas power engine, a valve is installed between the second gas tank and the compressed gas power engine, the compressed gas power engine drives the first compressor to supply gas to the second gas tank.

6. The system of claim 5, wherein the gas re-filling device further comprises a second compressor, the compressed gas power engine drives the generator to supply electricity to the second compressor so as to enable the second compressor to supply gas to the second gas tank.

7. A hybrid power system for an electric vehicle, comprising a motor and the hybrid electricity system of claim 1, wherein the motor serves as a power source of the electric vehicle, the battery or the compressed gas power engine drives the generator to supply electricity to the motor.

8. A vehicle, comprising the hybrid power system of claim 7.

9. The vehicle of claim 8, wherein the vehicle has a fossil fuel engine.
